(19) United States
(12) Patent Application Publication
(10) Pub. No.: US 2011/0058386 A1
(43) Pub. Date: Mar. 10, 2011

(54) INTEGRATED ELEMENT FOR THE ILLUMINATION OF A NUMBER PLATE AND FOR THE OPENING OF A DOOR OF A VEHICLE

(75) Inventor: Giovanni Andrea Penna, Collegno (IT)

(73) Assignee: Olsa S.p.A., Rivoli (IT)

(21) Appl. No.: 12/634,332

(22) Filed: Dec. 9, 2009

(30) Foreign Application Priority Data
Sep. 8, 2009 (IT) TO2009A000690

(51) Int. Cl. B60Q 3/00

(52) U.S. Cl. 362/544; 362/543; 362/497

(57) ABSTRACT

An integrated element (1) for the illumination of a number plate (101) and for the opening of a door (100) of a vehicle includes an extended body that acts as an opening handle of the door (100) and can be grasped by a user; and a plurality of illumination lights (6) of the number plate (101), housed within the body. The integrated element (1) includes a plastic module (5), inserted within the extended body and integrating: an opening electric element (7) of the door and the plurality of illumination lights (6). The lights possess an operating life duration higher than the expected mean-life of the vehicle.

This application claims benefit of Serial No. TO2009A000690, filed 8 Sep. 2009 in Italy and which application is incorporated herein by reference. To the extent appropriate, a claim of priority is made to the above disclosed application.

### BACKGROUND OF THE INVENTION

The present invention refers to the field of the accessories for vehicles and in detail it refers to an integrated element for the illumination of a number plate and for the opening of a door of a vehicle.

It is known that the vehicles currently available on the market use lights for the illumination of the number plate and of handles or equivalent devices for enabling the opening of the rear door of the vehicle.

Usually, in particular in hatchback vehicles, wherein the rear door constitutes one piece with the rear window, the number plate is positioned on the rear door itself. For this reason, there is the need of having handles for the opening of the rear door that integrate also the number plate lights that therefore create integrated elements of opening/illumination.

However, the handles of known kind, do not allow the optimization of the releasing function of the rear door itself, requiring therefore an external control for this function.

Furthermore, the handles of known kind, present the disadvantage of not allowing an efficient integration of the illumination components, that brings to a reduction of the costs for the production of the integrated element.

### SUMMARY OF THE INVENTION

The purpose of the present invention is to describe an integrated element for the illumination of a number plate and for the opening of a door of a vehicle that is free from the above described disadvantages.

According to the present invention, an integrated element for the illumination of a number plate and for the opening of a door of a vehicle is realized.

### BRIEF DESCRIPTION OF THE DRAWINGS

The invention will be now described with reference to the appended drawings, that illustrate a not restrictive example of embodiment, wherein:

FIG. 1 shows a perspective view of an integrated element for the illumination of a number plate and for the opening of a door of a vehicle according to the present invention, mounted on a rear door of a vehicle;

FIG. 2 shows a plan view of a lower face of the integrated element of FIG. 1;

FIG. 3 shows a perspective view of an inner part of the element of FIG. 1, disassembled from the rear door;

FIG. 4 shows a perspective view of the integrated element of FIG. 1, shown from a rear wall, that is used leaned on the rear door of the vehicle;

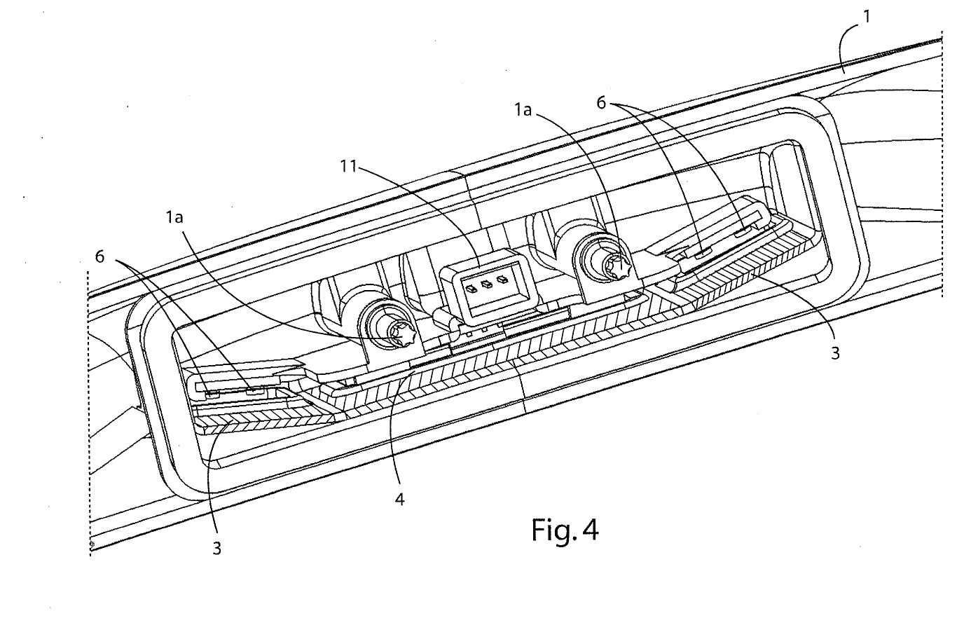

FIG. 5 shows a detail of an inner part of the integrated element of FIG. 1.

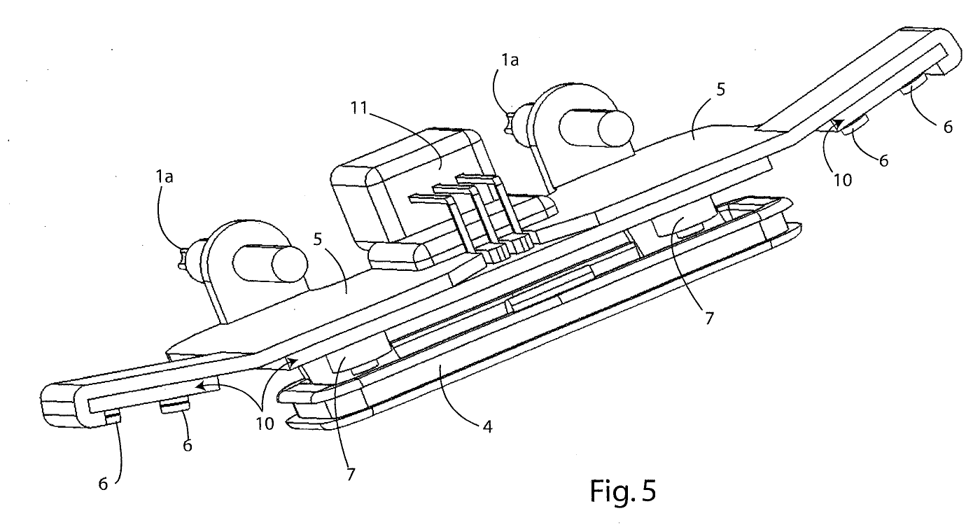

### DETAILED DESCRIPTION OF THE DRAWINGS

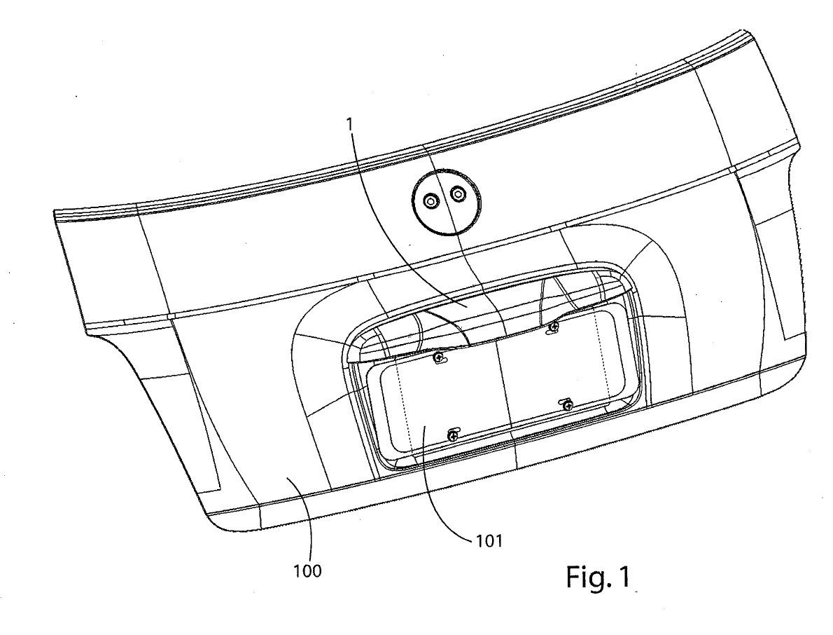

With reference to FIG. 1, an integrated element for the illumination of a number plate and for the opening of a door of a vehicle is generally designated with the reference number 1.

The integrated element 1 comprises an extended body that acts as opening handle of the door 100 of a vehicle. In detail, the FIG. 1 shows a door 100 of a hatchback vehicle.

The body of the integrated element 1 comprises also a plurality of lights for illuminating the number plate 101 of the vehicle upon which the integrated element 1 itself is installed.

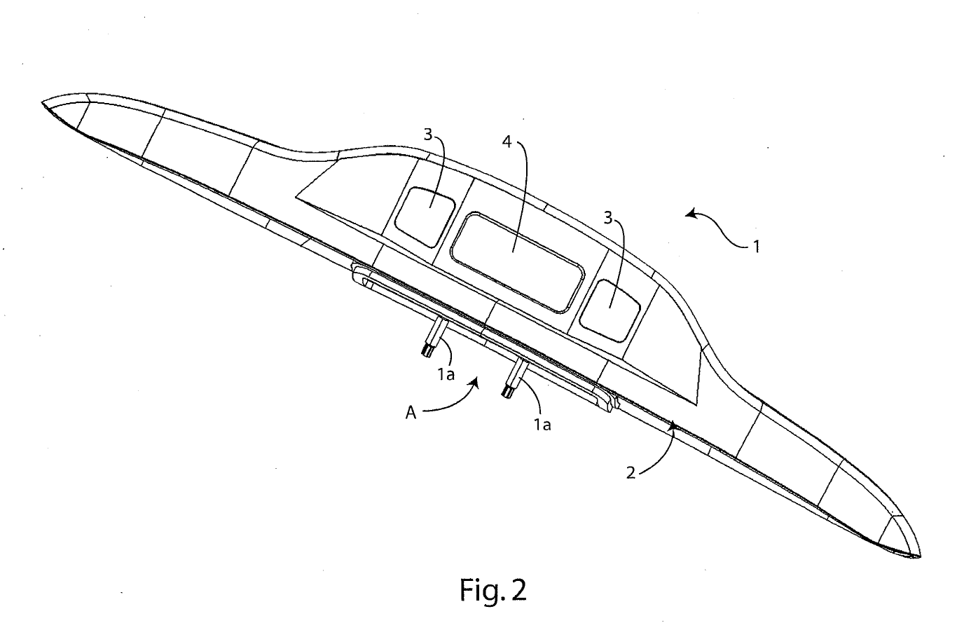

In detail, as it is shown in FIG. 2, a lower surface 2 of the integrated element 1 houses, in a preferably central area, a pair of plates in transparent plastic material 3, in detail polymethyl methalacrylate, and a central element 4 in rubber material (thermoplastic rubber), interposed between the pair of plates 3, that as first feature enables to be pushed up by a pressure exerted by the vehicle user's fingers for permitting the opening of the door 100 and, furthermore, permits to insulate the interior of the integrated element 1 from the external environment, thus realizing a weather strip because it is inserted in an opening obtained on said lower surface.

Finally, the body of the integrated element 1 comprises a pair of pins 1a for fixing it to the door 100 of the vehicle.

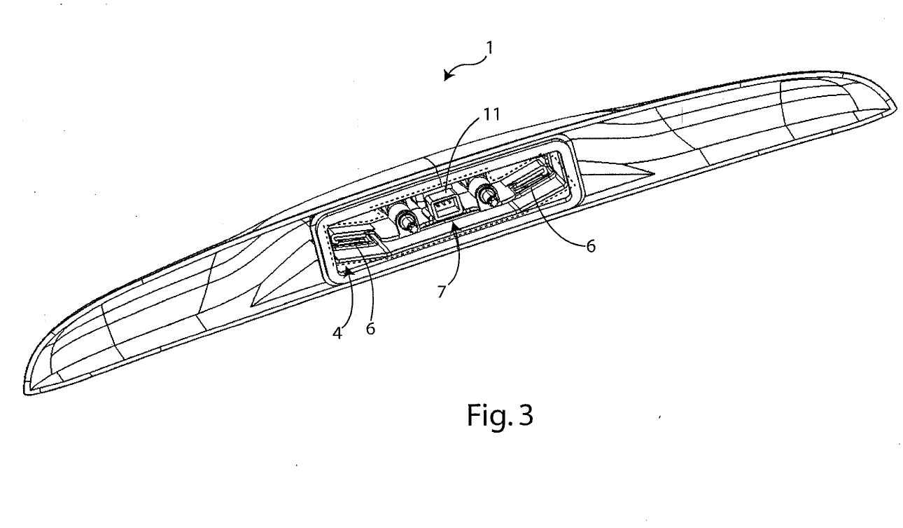

As shown in FIG. 3, which shows the integrated element 1 from a rear part in contact—in use—with the door 100 of the vehicle (that is in the direction of the arrow A of FIG. 2), the body of the integrated element 1 is hollow inside it, thus having a room for housing a plastic module 5, that houses, in a unique integrated element, a plurality of illumination lights 6 of the number plate 101 and a plurality of micro-switches 7, which create an opening electric element of the door 100 of the vehicle.

More in detail, as it can be seen from the fourth figure, the plurality of lights 6 is mounted side by side to said plurality of micro-switches 7, on their left and right respectively, exactly as it is for the pair of plates in transparent plastic material 3, that are separated between them by a central element 4. Therefore, also the micro-switches 7 separate the plurality of lights 6, in such a way that the plurality of lights 6, on the left and on the right of the micro-switches 7 respectively, is over the respective plate in transparent plastic material 3 as well as the central element 4 is overhung by the plurality of micro-switches.

In detail, the lights 6 are of LED-type, that is light-emitting diode lights, in such a way as to ensure a long duration and a low absorption of electric power during the illumination of the number plate 101.

The plastic module 5 also comprises a printed circuit 10 to which the lights 6 and the micro-switches 7 are welded and also housing the appropriate electric circuits that permit the supply to said lights and switches from an electric energy source external to the integrated element 1.

Because of the easy mounting even of robotized type, the lights 6 and the micro-switches 7 are surface mounted (SMD).

Eventually the element 1 comprises a multipolar connector 11, fixed to the plastic module 5 and having a plurality of electric transmission lines 5a connected to the printed circuit 10; a power connector (not shown) through which it is possible to supply electric power to the lights 6 and send/receive a signal sₐ(t) of the opening of the vehicle door 100 is fixed to it.

In detail, the opening signal sₐ(t) depends on the typology of the micro-switches 7; in fact, if they are of the normally open type, said signal is shown at the moment of an opening action, that is of a pressure made by the user on the central element 4, and corresponds to a circuit closing signal; the other way around, if the micro-switches 7 are of the normally closed type, at the opening of the door 100, the opening signal sₐ(t) will correspond to a circuit opening signal.

Obviously, the micro-switches 7 do not act directly on the lock of the door 100, but act on a servomechanism, that is not shown in the attached figures because it is not a part of the present invention.

The presence of a plurality of micro-switches 7 is given by the need of ensuring a redundancy of the opening command of the door 100, as well as, particularly when the central element 4 is very wide, more switching safety of at least one of the switches; in fact, for causing the release of the vehicle's door 100, it is sufficient that one of the micro-switches switches.

The integrated element 1 is realized without means for the non destructive access to said cavity, that is considering that, if one of the components inside the body breaks down, the entire integrated element 1 is to be substituted.

The advantages of the integrated element for the illumination of a number plate and for the opening of a door of a vehicle, the object of the present invention, are known in the light of the preceding description. In particular, it enables to integrate in a unique element an opening command of a door of a vehicle and an illumination device of its number plate, so that the integrated element 1 can be cheaply produced.

The presence of LED lamps, whose operating life is very high if compared to halogen or filament lamps, enables to realize a device that can be sealed without the need for providing means for its opening for the substitution of the lamps themselves, because the duration of a LED lamp is typically higher than the mean life of a vehicle upon which the object of the present invention is installed.

In this way, it is possible to improve the insulation from the external environment of the printed circuit 10, realizing a better dirt, impurity, humidity or corrosive/oxidant agents tightness.

It is eventually clear that some variants, improvements or additions, obvious for a technician expert in the art, can be applied to the integrated element 1 object of the present invention, without exiting from the protective scope given by the appended claims.

In particular, it is clear that the luminous source (lights) for the illumination of the number plate is not necessarily limited to a LED one; other luminous sources can be used, provided that the requirements of a mean life higher or equal to the operating life of the vehicle upon which the integrated element object of the present invention is installed are present.

For this reason, regardless of the illumination light of the number plate inserted into the integrated element object of the present invention, its mean time between failures (MTBF) or its operating life expectation must be of “long operating life”.

1) An integrated element for the illumination of a number plate and for the opening of a door of a vehicle, said integrated element comprising:
an extended body acting as an opening handle of said door and configured for being grasped by a user; and
a plurality of illumination lights of said number plate, housed within said body;
said integrated element comprising a plastic module, inserted within said extended body and integrating:
an opening electric element of said door; and
said plurality of illumination lights; wherein said plurality of illumination lights possesses an operating life duration higher than the forecasted mean-life of said vehicle.

2) An integrated element according to claim 1, further comprising a printed circuit, fixed to said plastic module, upon which said opening electric command of said door and said illumination lights are housed.

3) An integrated element according to claim 2, wherein said opening electric command comprises a plurality of micro-switches welded to said printed circuit.

4) An integrated element according to claim 3, further comprising a covering element of flexible material, wherein said micro-switches are insulated from the external environment through said covering element of flexible material.

5) An integrated element according to claim 4, wherein said flexible material is thermoplastic rubber, and wherein a dimension of said covering element is such that said covering element adapts to an opening of a lower surface of said integrated element for realizing a seal.

6) An integrated element according to claim 2, wherein said illumination lights are surface mounted light-emitting diodes.

7) An integrated element according to claim 2, further comprising a connector, electrically connected to said printed circuit through a plurality of lines; said connector is designed to house a power and transport connector of electric signals from and to said opening electric command and to said illumination lights.

8) An integrated element according to claim 2, further comprising a plurality of transparent coverings for said illumination lights; said transparent coverings being fixed to said extended body and allowing the transmission of light emitted by said illumination lights toward said number plate.

9) An integrated element according to claim 1, wherein said plastic module is polyamide.

10) An integrated element according to claim 8, wherein said transparent coverings are polymethyl methalacrylate.

11) An integrated element according to claim 1, wherein said integrated element does not provide for means for substituting of said illumination lights, said printed circuit, said switches or said connector.
